(19) United States
(12) Patent Application Publication
(10) Pub. No.: US 2016/0343003 A1
(43) Pub. Date: Nov. 24, 2016

(54) SYSTEMS AND METHODS FOR ENHANCED MERCHANT DATA USING SATELLITE IMAGING

(71) Applicant: MasterCard International Incorporated, Purchase, NY (US)

(72) Inventor: Justin X. Howe, San Francisco, CA (US)

(21) Appl. No.: 14/714,491

(22) Filed: May 18, 2015

(51) Int. Cl. G06Q 30/02

(52) U.S. Cl. CPC G06Q 30/0201

(57) ABSTRACT

A computer-implemented method for determining merchant sales data using overhead imagery is provided. The method uses a valuation computer device in communication with a memory. The method includes receiving a first overhead image of an area surrounding a merchant location. The first overhead image is associated with a first image date and time. The method also includes identifying at least one parking area associated with the merchant location based on the first overhead image, determining a first number of vehicles in the at least one parking area, receiving a plurality of transaction data associated with the merchant location for a first predefined period of time associated with the first image date and time, and determining a first set of sales data for the merchant based on the plurality of transaction data and the first number of vehicles.

### BACKGROUND OF THE DISCLOSURE

The field of the disclosure relates generally to enhancing merchant data, and more specifically to method and systems for determining sales volume for a merchant location based on overhead imagery of vehicles in a parking area.

In today's business world, many decisions are made based on information products. Information products are collections of data that are analyzed and represented in useful ways for the variety of businesses that rely on them. They reveal consumer trends, financial trends, regional and demographic information, and much more. The more accurate and truly representational of the sample population about which they are produced, the more useful information products can be—and the more businesses will want to purchase and utilize them.

For example, payment processing companies (e.g., MasterCard®, VISA®, American Express®, and First Data Corp.®) want to determine their respective share of transactions initiated at a particular merchant location, in part to then estimate the total revenue generated at the merchant location—and the share of said revenue generated by their cardholders. The current method of estimating a percentage share of revenue from cardholders of the various payment card processing companies includes purchasing regional credit card information from credit-reporting agencies such as Experian®. This information provides the number of American Express®, VISA®, and MasterCard® credit cards issued in a particular zip code or set of zip codes. From this information, a relative share or ratio of the credit-card based transactions in that particular zip code or area related to the set of zip codes is inferred.

It is clear that this method of estimating the respective share of transactions attributable to each payment processing company is limited in its accuracy and granularity. The same estimate of percentage share is used at every merchant location in the area or zip code. Moreover, cash, check, and debit card data payment is not available from any particular agency, so that data, too, must be assumed, which only compounds the potential error in these estimates. Accordingly, the resulting information product, namely the estimation of merchant revenue, is limited in its value.

### BRIEF DESCRIPTION OF THE DISCLOSURE

In one embodiment, a computer-implemented method for determining merchant sales data using overhead imagery is provided. The method uses a valuation computer device in communication with a memory. The method includes receiving, by the valuation computer device, a first overhead image of an area surrounding a merchant. The first overhead image is associated with a first image date and time. The method also includes identifying at least one parking area associated with the merchant location based on the first overhead image, determining, by the valuation computer device, a first number of vehicles in the at least one parking area based on the first overhead image and the at least one parking area, receiving, by the valuation computer device, a plurality of transaction data associated with the merchant location for a first predefined period of time associated with the first image date and time, and determining, by the valuation computer device, a first set of sales data for the merchant location based on the plurality of transaction data and the first number of vehicles.

In another embodiment, a valuation computing device for determining merchant sales data using overhead imagery is provided. The valuation computing device includes one or more processors communicatively coupled to one or more memory devices. The valuation computing device is configured to receive a first overhead image of an area surrounding a merchant. The first overhead image is associated with a first image date and time. The valuation computing device is further configured to identify at least one parking area associated with the merchant location based on the first overhead image, determine a first number of vehicles in the at least one parking area based on the first overhead image and the at least one parking area, receive a plurality of transaction data associated with the merchant location for a first predefined period of time associated with the first image date and time, and determine a first set of sales data for the merchant location based on the plurality of transaction data and the first number of vehicles.

In yet another embodiment, a computer-readable storage medium having computer-executable instructions embodied thereon is provided. When executed by a valuation computing device having at least one processor coupled to at least one memory device, the computer-executable instructions cause the at least one processor to receive a first overhead image of an area surrounding a merchant. The first overhead image is associated with a first image date and time. The computer-executable instructions also cause the at least one processor to identify at least one parking area associated with the merchant location based on the first overhead image, determine a first number of vehicles in the at least one parking area based on the first overhead image and the at least one parking area, receive a plurality of transaction data associated with the merchant location for a first predefined period of time associated with the first image date and time, and determine a first set of sales data for the merchant location based on the plurality of transaction data and the first number of vehicles.

### BRIEF DESCRIPTION OF THE DRAWINGS

FIGS. 1-9 show example embodiments of the methods and systems described herein.

FIG. 1 is a schematic diagram illustrating an example multi-party transaction card industry system for enabling payment-by-card transactions in which merchants and card issuers do not need to have a one-to-one relationship.

FIG. 2 is a simplified block diagram of an example system used for determining sales volume for a merchant location based on overhead imagery of the vehicles in a parking area.

FIG. 3 illustrates an example configuration of a client system shown in FIG. 2, in accordance with one embodiment of the present disclosure.

FIG. 4 illustrates an example configuration of a server system shown in FIG. 2, in accordance with one embodiment of the present disclosure.

FIG. 5 is a block diagram of an example system for determining sales volume for the merchant location based on an overhead image of the vehicles in a parking area using the system shown in FIG. 2.

FIG. 6A is a graphical view of an example view of a section of the parking area shown in FIG. 5 at a time T=0.

FIG. 6B is a graphical view of the example view of the section of the parking area shown in FIG. 5 at a time T=1.

FIG. 7 is a flowchart showing a process for determining sales data for the merchant location based on the overhead image of the vehicles in a parking area as shown in FIG. 5 using the system shown in FIG. 2.

FIG. 8 is a flow chart of a process of identifying at least one parking area and determining a number of vehicles in the at least one parking area as shown in FIG. 7.

FIG. 9 is a diagram of components of one or more example computing devices that may be used in the system shown in FIG. 2.

### DETAILED DESCRIPTION OF THE DISCLOSURE

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. This system and method aggregates overhead parking area images with cardholder transactions at a merchant location to determine sales volume for the merchant based on vehicles in the parking area.

In the example embodiment, a payment card processing network receives a plurality of payment transactions for processing. The processing network stores these payment transactions in a database. A valuation and imaging analysis (“VIA”) computer device (also known as a valuation computing device) is in communication with the payment network and with one or more overhead image sources. The VIA computer device receives, from one of the overhead image sources, an overhead image of an area surrounding a merchant location. In the example embodiment, the overhead image is generated by a satellite. In other embodiments, the overhead imagery may be generated by a drone or aircraft or any other method or device capable of capturing overhead images of parking areas associated with the merchant location. The VIA computer device analyzes the overhead image to identify at least one parking area associated with the merchant location. The VIA computer device determines a number of vehicles in the parking area from the overhead image. The overhead image also includes a date and time that the overhead image was generated. The VIA computer device requests from the payment network transaction data related to all payment transactions that occurred at the merchant location within a predetermined time of the date and time of the overhead image. The VIA computer device receives the requested transaction data from the processing network. The VIA computer device determines sales data for the merchant location based on the number of vehicles calculated in the parking area and the number of transactions that occurred.

In some embodiments, the VIA computer device receives multiple overhead images of the merchant location generated at multiple points in time. The VIA computer device compares the sales data between the different points in time. By comparing the sales data from the multiple points in time, the VIA computer device determines trends (such as when an amount spent on average per shopper is higher) and can determine the effectiveness of advertising campaigns. In some embodiment where the difference in time between overhead images is low (e.g., less than 20 minutes), the VIA computer device is able to determine an approximate length of time that each vehicle and thus each consumer stayed at the merchant location.

In some embodiments, the VIA computer device only receives transaction data associated with a portion of the transactions associated with a first payment network. In these embodiments, the VIA computer device determines the total sales value based on the proportion of transactions that are transactions from the first payment network to the total number of transactions.

In some other embodiments, the number of vehicles in the parking area could be used to determine a number of visitors to the store. The number of vehicles could also estimate a number of vehicle passengers that visit the store, where there is more than one passenger in a vehicle

The methods and systems described herein may be implemented using computer programming or engineering techniques including computer software, firmware, hardware, or any combination or subset. As disclosed above, at least one technical problem with prior systems is that the estimation of merchant revenue is general to an area rather than specific to each merchant location. The systems and methods described herein address that technical problem. The technical effect of the systems and processes described herein is achieved by performing at least one of the following steps: (a) receiving a first overhead image of an area surrounding a merchant location, wherein the first overhead image associated with a first image date and time; (b) identifying at least one parking area associated with the merchant location based on the first overhead image; (c) determining a first number of vehicles in the at least one parking area based on the first overhead image and the at least one parking area; (d) receiving a plurality of transaction data associated with the merchant location for a first predefined period of time associated with the first image date and time; (e) determining a first set of sales data for the merchant location based on the plurality of transaction data and the first number of vehicles; (f) receiving a second overhead image of the area surrounding the merchant location, wherein the second overhead image associated with a second time date and time; (g) determining a second number of vehicles in the at least one parking area based on the second overhead image and the at least one parking area; (h) receiving a plurality of transaction data associated with the merchant location for a second predefined period of time associated with the second image date and time; (i) determining, by the valuation computer device, a second set of sales data for the merchant location based on the plurality of transaction data and the second number of vehicles; (g) comparing at least the first set of sales data and the second set of sales data; and (h) determining at least one trend based on the comparison. The resulting technical effect is that a more accurate estimation of merchant revenue is generated, where the estimation is specific to an individual merchant location.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

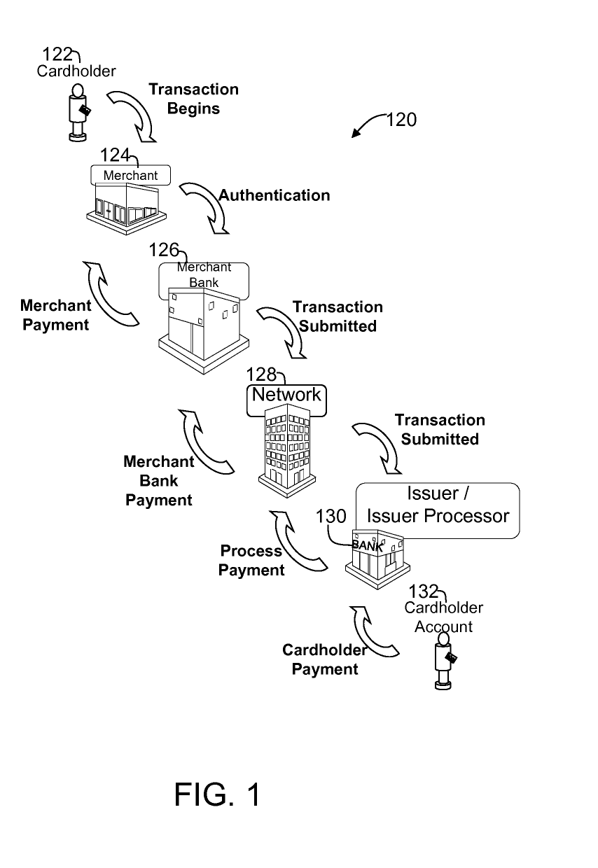

FIG. 1 is a schematic diagram illustrating an example multi-party transaction card industry system 120 for enabling payment-by-card transactions in which merchants 124 and card issuers 130 do not need to have a one-to-one relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card or electronic payments account identifier, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

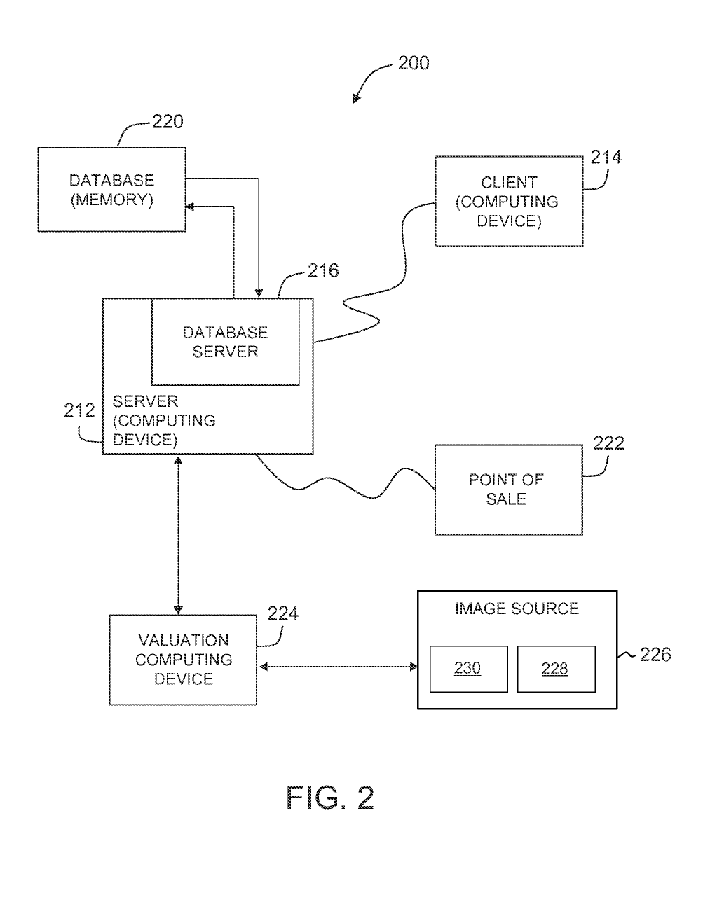

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

FIG. 2 is a simplified block diagram of an example system 200 used for determining sales volume for a merchant location based on overhead imagery of vehicles in a parking area. In the example embodiment, system 200 may be used for performing payment-by-card transactions received as part of processing cardholder transactions. In addition, system 200 is a payment processing system that includes a valuation and imaging analysis (“VIA”) computer device 224 configured to determine sales volume for a merchant location based on overhead imagery of the vehicles in the parking area. As described below in more detail, VIA computer device 224 is configured to receive a first overhead image of an area surrounding a merchant, identify at least one parking area associated with the merchant location based on the first overhead image, determine a first number of vehicles in the at least one parking area based on the first overhead image and the at least one parking area, receive a plurality of transaction data associated with the merchant location for a first predefined period of time associated with the first image date and time, and determine a first set of sales data for the merchant location based on the plurality of transaction data and the first number of vehicles in the parking area.

In the example embodiment, client systems 214 are computers that include a web browser or a software application to enable client systems 214 to access server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment.

A database server 216 is communicatively coupled to a database 220 that stores data. In one embodiment, database 220 includes transaction information from a plurality of cardholders and paths based on those transactions. In the example embodiment, database 220 is stored remotely from server system 212. In some embodiments, database 220 is decentralized. In the example embodiment, a person can access database 220 via client systems 214 by logging onto server system 212, as described herein.

One or more point of sale systems 222 are communicatively coupled with the server system 212. The one or more point of sale systems 222 can be merchants 124 shown in FIG. 1, where point of sale systems 222 are communicatively coupled with server system 212 through payment network 120. Point of sale systems 222 may be, but are not limited to, machines that accept card swipes, online payment portals, or stored payment card numbers for recurring transactions.

VIA computer device 224 is communicatively coupled with server system 212. VIA computer device 224 can access server system 212 to store and access data and to communicate with client systems 214 through the server system 212. In some embodiments, VIA computer device 224 may be associated with, or is part of payment network 120, or in communication with payment network 120, shown in FIG. 1. In other embodiments, VIA computer device 224 is associated with a third party and is in communication with payment network 120. In some embodiments, VIA computer device 224 may be associated with, or be part of merchant bank 126, interchange network 128, and issuer bank 130, all shown in FIG. 1.

One or more image sources 226 are communicatively coupled with VIA computer device 224. As described in detail below, the one or more image sources 226 provide overhead images of merchant locations associated with merchants 124 to VIA computer device 224. In the example embodiment, image source 226 includes an image generator 228 and an image source computer device 230. Image generator 228 may be a satellite, airplane, drone, light pole camera, or other source capable of providing an overhead image of a parking area. In some embodiments, image generator 228 is capable of generating images in the infrared spectrum or other wavelengths in addition to the visible light spectrum. Image source computer device 230 may be communicatively coupled to a single image generator 228 or a plurality of image generators 228. Image source computing device 230 receives overhead images from image generator 228, stores the overhead images, and transmits the images to VIA computer device 224. In some embodiments, communication between VIA computer device 224 and image source computer device 230 is two-way. In these embodiments, VIA computer device 224 requests one or more overhead images from image source computer device 230, which transmits the requested overhead images to VIA computer device 224.

In some embodiments, server system 212 may be associated with the financial transaction interchange network 128 shown in FIG. 1, and may be referred to as an interchange computer system. Server system 212 may be used for processing transaction data and analyzing for fraudulent transactions. In addition, at least one of client systems 214 may include a computer system associated with an issuer of a transaction card. Accordingly, server system 212 and client systems 214 may be utilized to process transaction data relating to purchases a cardholder makes utilizing a transaction card processed by the interchange network and issued by the associated issuer. At least one client system 214 may be associated with a user or a cardholder seeking to register, access information, or process a transaction with at least one of the interchange network, the issuer, or the merchant. In addition, client systems 214 or point of sale devices 222 may include point-of-sale (POS) devices associated with a merchant and used for processing payment transactions. At least one client system 214 may be used for investigating potential breaches.

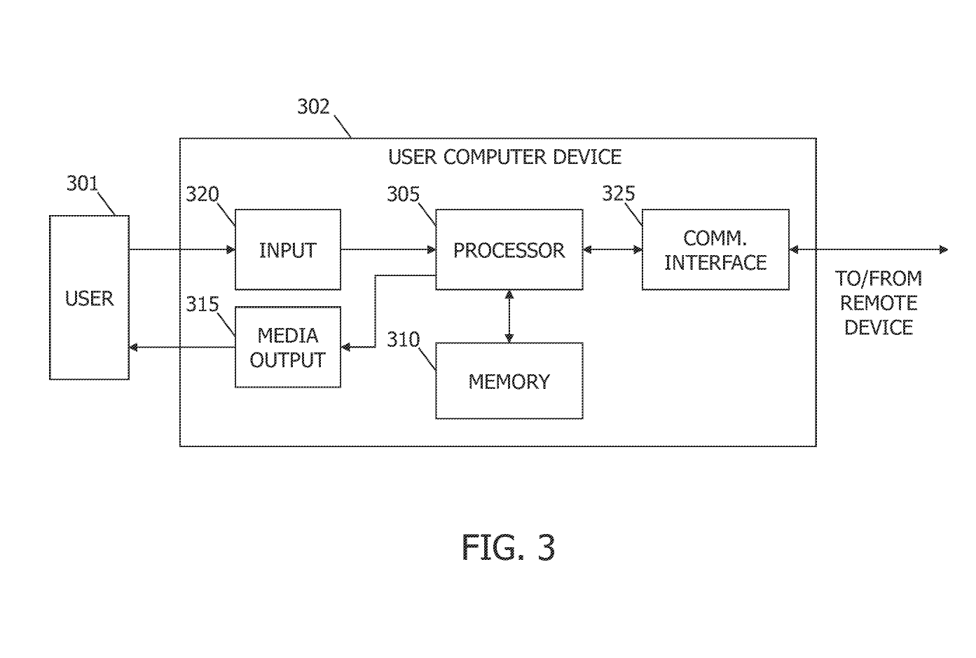

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214, VIA computer device 224, and image source computer device 230 (all shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as server system 212 (shown in FIG. 2). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from server system 212. A client application allows user 301 to interact with, for example, server system 212. For example, instructions may be stored by a cloud service, and the output of the execution of the instructions sent to the media output component 315.

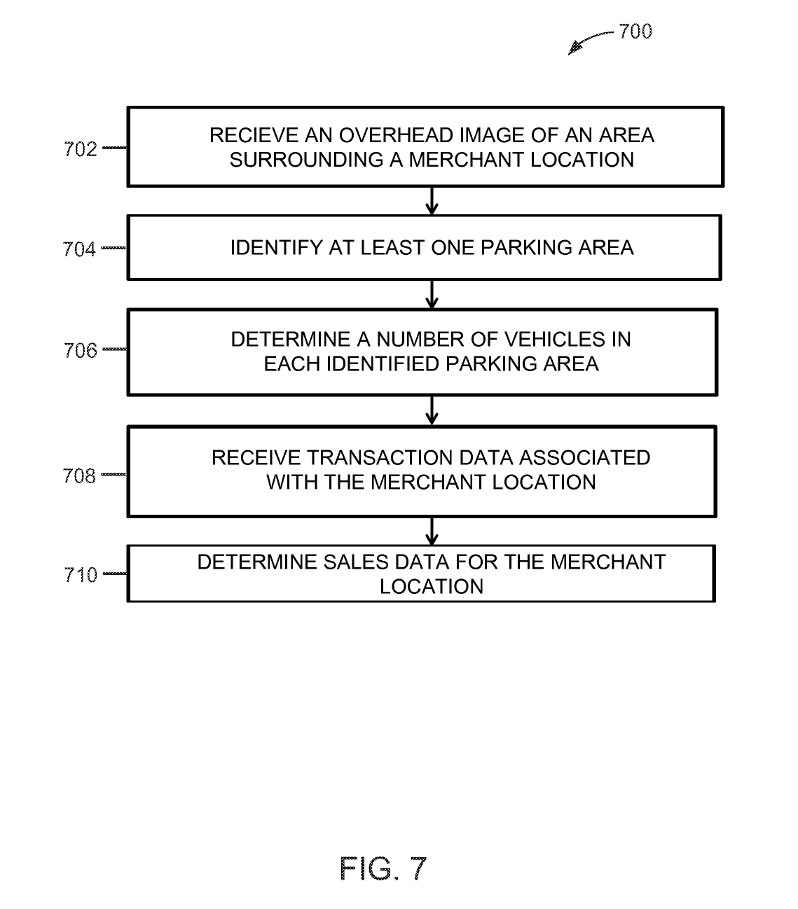

Processor 305 executes computer-executable instructions for implementing aspects of the disclosure. In some embodiments, processor 305 is transformed into a special purpose microprocessor by executing computer-executable instructions or by otherwise being programmed For example, processor 305 is programmed with the instruction such as illustrated in FIGS. 7 & 8.

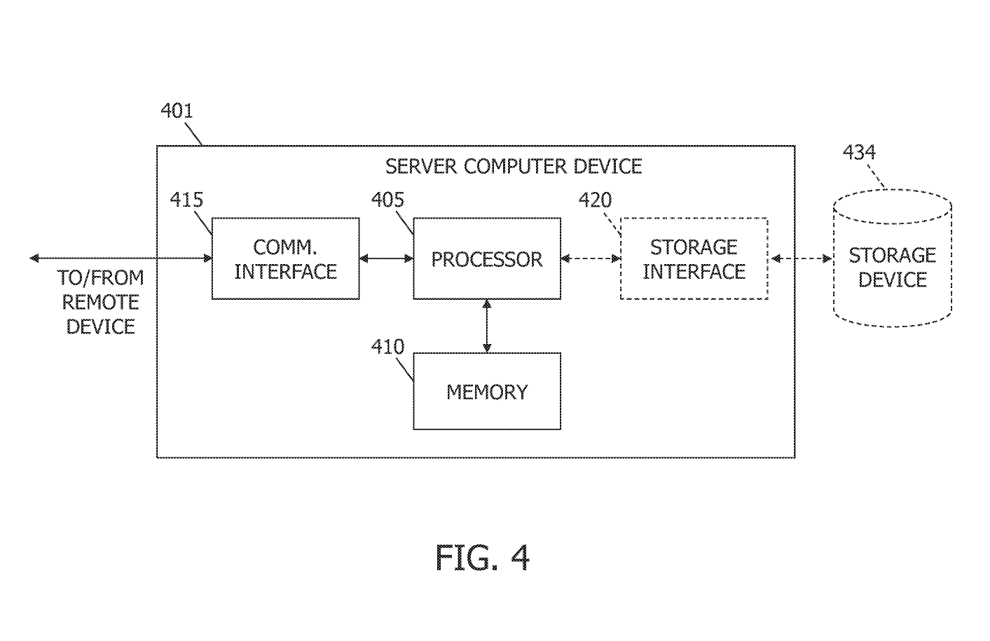

FIG. 4 illustrates an example configuration of server system 212 shown in FIG. 2, in accordance with one embodiment of the present disclosure. Server computer device 401 may include, but is not limited to, database server 216 and server system 212 (both shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, or VIA computer device 224 (both shown in FIG. 2). For example, communication interface 415 may receive requests from client systems 214 via the Internet.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

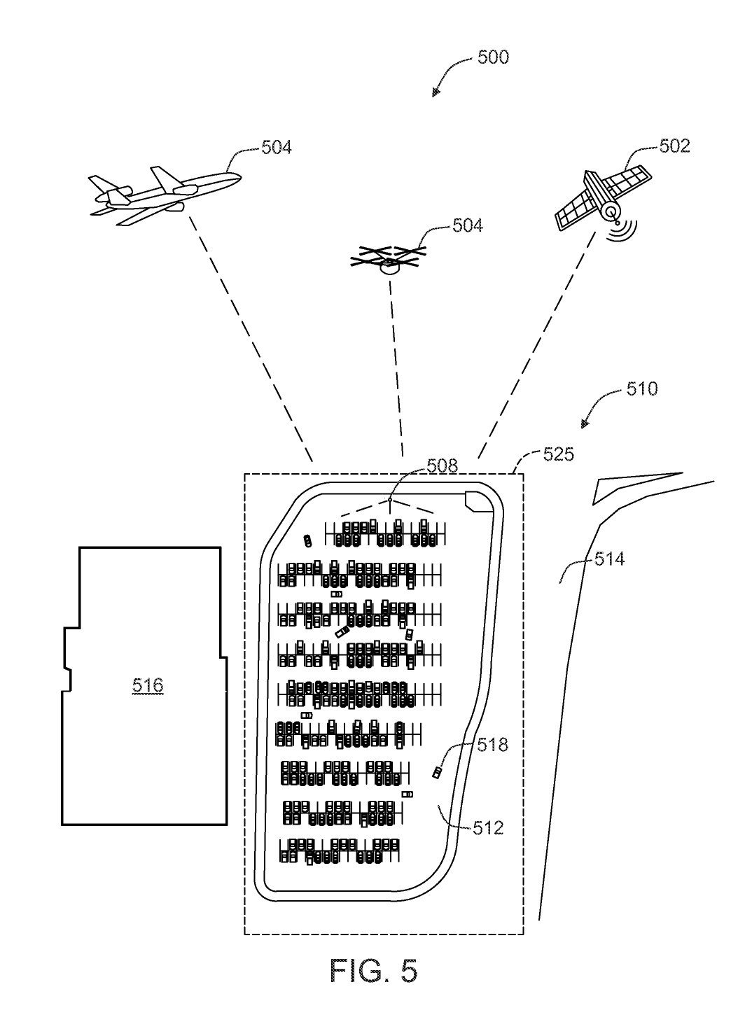

FIG. 5 is a block diagram of an example system 500 for determining sales volume for a merchant location 516 based on an overhead image 510 of vehicles 518 in a parking area 512 using system 200 shown in FIG. 2. System 500 includes multiple potential sources of overhead images 510, such as image generator 228, shown in FIG. 2. Image generator 228 may include satellites 502, planes 504, drones 506, and light-pole cameras 508. These image generators provide overhead images 510 of merchant location 516 and an area 525 around merchant location 516.

Overhead image 510 includes roadways 514, merchant locations 516, parking areas 512, and vehicles 518 in parking area 512. In the example embodiment, overhead image 510 includes a single merchant location 516 associated with a single parking area 512. In another embodiment, overhead image 510 includes a single merchant location 516 and multiple parking areas 512. In yet another embodiment, overhead image 510 includes multiple merchant locations 516 associated with a single parking area 512, such as at a strip mall. In the example embodiment, parking area 512 includes single story parking lots, where the entire parking area 512 is visible to overhead views.

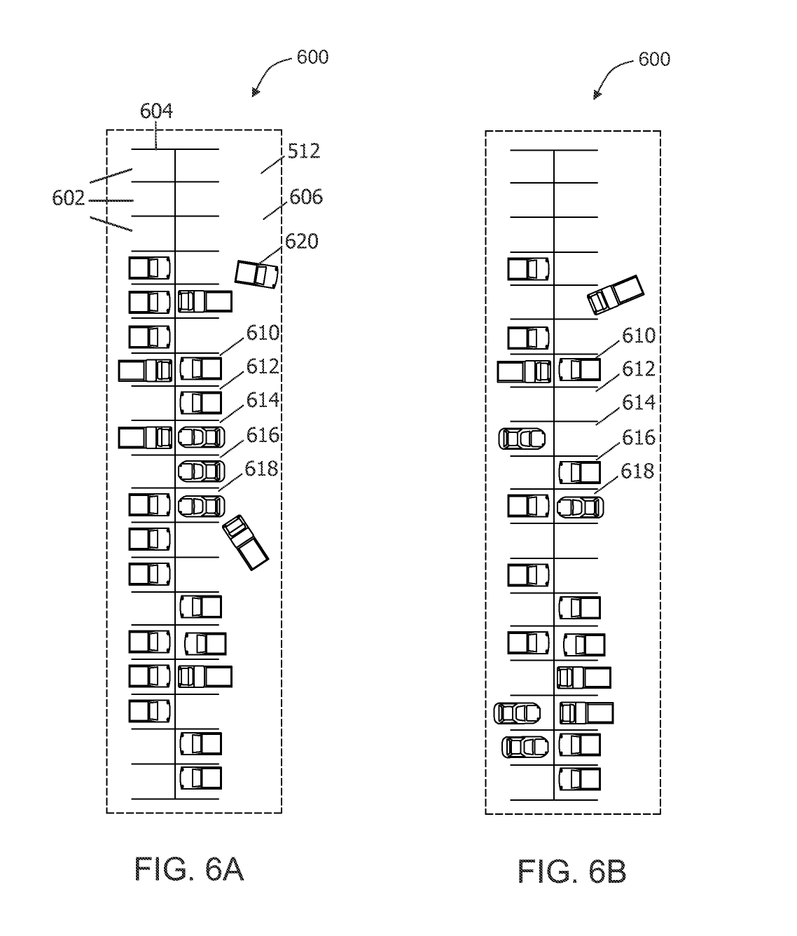

FIGS. 6A and 6B are graphical views of an example view 600 of a section of parking area 512 shown in FIG. 5 at times T=0 and T=1, respectively. These two FIGS. show an example of potential changes to parking area 512 over time. View 600 displays a plurality of parking spaces 602 divided by parking lot lines 604. View 600 also displays parking area surface 606, which in the example embodiment is blacktop. Other non-limiting examples of parking area surfaces 606 include concrete, grass, bare dirt, gravel, brick, cobble, or other material where vehicles are parked. View 600 further displays vehicles 620. Additionally, view 600 displays a set of adjacent parking spaces 610, 612, 614, 616, and 618. In FIG. 6A, adjacent parking spaces 610, 612, 614, 616, and 618 are each occupied by a vehicle 620. In FIG. 6B, parking spots 612 and 614 are currently empty and parking spot 616 is occupied by a different vehicle than was there in FIG. 6A.

FIG. 7 is a flowchart showing a process 700 for determining sales data for a merchant location 516 based on overhead image 510 of vehicles 518 in a parking area 512 as shown in FIG. 5 using system 200 shown in FIG. 2. In the example embodiment, process 700 is performed by VIA computer device 224 (shown in FIG. 2).

VIA computer device 224 receives 702 an overhead image 510 of an area 525 surrounding a merchant location 516 (all shown in FIG. 5). In the example embodiment, VIA computer device 224 receives 702 overhead image 510 from image source 226 (shown in FIG. 2). VIA computer device 224 identifies 704 at least one parking area 512 in overhead image 510. VIA computer device 224 determines 706 a number of vehicles 518 in each identified parking area 512. VIA computer device 224 receives 708 transaction data associated with merchant location 516 from payment network 120 (shown in FIG. 1). In the example embodiment, overhead image 510 includes a date and time associated with when overhead image 510 was generated. VIA computer device 224 requests transaction data for a predetermined time before and after the date and time associated with overhead image 510. In the example embodiment, VIA computer device 224 requests the transaction data from server system 212, which stores the transaction data in database 220 (both shown in FIG. 2). The transaction data includes payment card transaction conducted at merchant location 516 within a predefined period of the date and time associated with overhead image 510. While in the example embodiment, the transaction data is related to transactions with a single payment network 120 (as shown in FIG. 1), in other embodiments, the transactions may be from a plurality of networks or may include non-payment card transactions.

VIA computer device 224 determines 710 sales data for the merchant location 516 for the date and time associated with overhead image 510. VIA computer device 224 determines 710 the sales data based on the transaction data and the number of vehicles 518 in the identified parking areas 512. For example, VIA computer device 224 determines a total sales volume for the merchant location 516 based on the transaction data. In some embodiments, the transaction data may be a known percentage of the total sales volume of merchant location 516. VIA computer device 224 extrapolates the total sales volume for merchant location 516 based on the known percentage and the received transaction data. VIA computer device 224 compares the total sales volume with the number of vehicles to determine 710 sales data such as average amount of sales per vehicle 518 and average amount of sales per visitor, where the average number of passengers in each vehicle 518 is known or predetermined

In additional embodiments, VIA computer device 224 performs process 700 for multiple overhead images 510, where each overhead image 510 is for a different point in time. VIA computer device 224 uses the sales data and number of vehicles 518 at each point in time to calculate trends and determine spending habits. For example, by comparing the sales data from the multiple points in time, VIA computer device 224 determines trends (such as when an amount spent on average per shopper is higher) and can determine the effectiveness of advertising campaigns. Additionally, VIA computer device 224 may use the trend data to modify the known percentage of total sales of the individual merchant locations 516 that the received transaction data comprises. In some embodiment where the difference in time between overhead images 510 is low (e.g., less than 20 minutes), VIA computer device 224 is able to determine an approximate length of time that each vehicle 518 and thus each consumer stayed at merchant location 516.

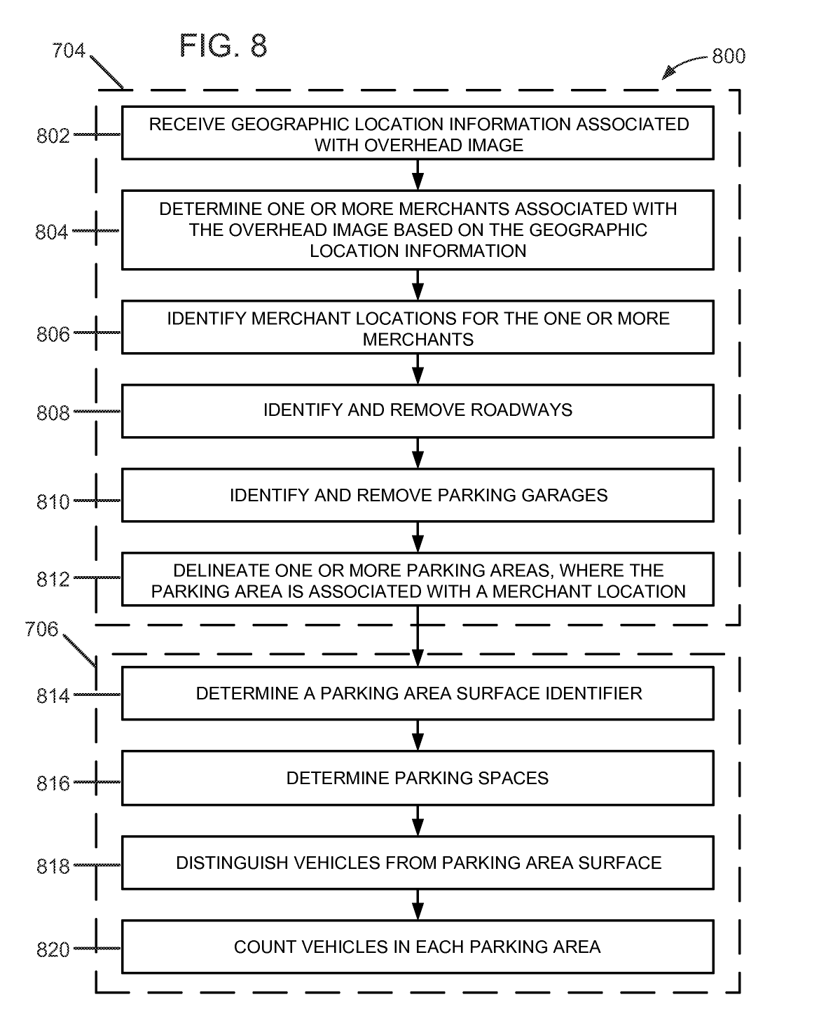

FIG. 8 is a flow chart of a process 800 of identifying 704 at least one parking area and determining 706 a number of vehicles in each parking area as shown in FIG. 7. In the example embodiment, process 800 is performed by VIA computer device 224 (shown in FIG. 2).

In identifying 704 at least one parking area, VIA computer device 224 receives 802 geographic location information associated with overhead image 510 (shown in FIG. 5). The geographic location information may include latitude and longitude information, physical street addresses, merchant location identifiers, and any other information necessary to identify the location of the area that overhead image 510 includes. VIA computer device 224 determines 804 one of more merchants 124 (shown in FIG. 1) associated with overhead image 510 based on the geographic location information. For example, VIA computer device 224 compares the geographic location information to a list of merchant locations 516, which may be stored in database 220 (shown in FIG. 2) to determine which merchant locations 516 are located in the area in overhead image 510. Based on overhead image 510, VIA computer device 224 identifies 806 merchant locations 516 in overhead image 510. In FIG. 5, there is only one merchant location 516 shown; however, in some embodiments, multiple merchant locations 516 may be included in overhead image 510. For example, VIA computer device 224 identifies the building or structure for the identified merchant location 516 through image recognition techniques

VIA computer device 224 identifies and removes 808 roadways 514 (shown in FIG. 5) from overhead image 510. In some embodiments, VIA computer device 224 contains a database, such as database 220, of known roadways 514 and use the geographic location information to identify roadways 514 in overhead image 510. In other embodiments, VIA computer device 224 identifies the roadways 514 in overhead image 510 based on shape and color. In the example embodiment, VIA computer device 224 identifies and removes 810 parking garages from overhead image 510. In the example embodiment, VIA computer device 224 stores locations of known parking garages in a database, such as database 220. VIA computer device 224 uses the geographic location information to identify the location of parking garages to separate the parking garages from the parking lots. While in the example embodiment parking garages are removed, in other embodiments, parking garages may be left in overhead image 510 and the top level of the parking garage, or any visible area of the parking garage is included as a parking area 512. In still other embodiments, VIA computer device 224 receives images from cameras interior to parking garages and counts vehicles inside of the parking garage based on those images.

VIA computer device 224 delineates 812 one or more parking areas 512. These parking areas 512 are associated with the identified merchant locations 516. In some embodiments, multiple parking areas 512 may be associated with a merchant location 516. For example, a merchant location 516 may have parking areas 512 in front, behind, or to the side of merchant location 516. Additionally, some parking areas 512 may be dedicated employee parking areas. VIA computer device 224 may not count the vehicles 518 (shown in FIG. 5) in parking areas 512 dedicated to employees. VIA computer device 224 may determine that a parking area 512 is dedicated to employees based on a lack a change in vehicles 518 in the parking area 512 over time. In other embodiments, employee parking areas may be predefined and stored in memory.

In some embodiments, multiple merchant locations 516 may be associated with the same parking area 512, such as in the case of a strip mall or shopping mall, with multiple merchant locations 516 in a row and a single parking area 512 in front of all of the merchant locations 516. In these embodiments, VIA computer device 224 may divide parking area 512 into portions, and associated each portion to a different merchant location 516. Also, VIA computer device 224 may divide the parking area based on the dispersement of vehicles 518 in parking area 512. If a large number of vehicles 518 are seen in a pattern emanating from a single merchant location, while the vehicles 518 around a different merchant location are sparse, then VIA computer device 224 may divide the parking area 512 based on the dispersement.

Additionally, VIA computer device 224 may delineate the parking areas 512 based on the color difference between parking area surface 606 (as shown in FIG. 6) and the area surrounding parking area 512. In embodiments that image generator 228 (shown in FIG. 2) is capable of generating overhead image 510 with infrared information, VIA computer device 224 delineates the one or more parking areas based on the wavelengths that the parking area surface 606 is emitting in comparison to the wavelengths emitted by other objections or areas in overhead image 510. In the example embodiment, VIA computer device 224 stores the delineated parking areas 512 to be able to quickly delineate parking areas 512 in future overhead images 510 of the same area.

In determining 706 a number of vehicles in each parking area, VIA computer device 224 selects a delineated parking area 512. VIA computer device 224 determines 814 a parking area surface identifier. The parking area surface identifier is an identifier that VIA computer device 224 uses to distinguish parking area surface 606 from other objects, such as vehicles 518, in parking area 512 of overhead image 510. For example, the parking area surface identifier may be a color or wavelength associated with the parking area surfaces 606 of the selected parking area 512. For example, on a hot sunny day in August the parking area surface 606 may be emitting a different wavelength in infrared as the parking area surface 606 may be emitting in February. VIA computer device 224 determines parking spaces 602 (shown in FIG. 6A) in the selected parking area 512. In the example embodiment, VIA computer device 224 uses the difference in color between parking area surface 606 and parking lot lines 604 to determine parking spaces 602. In other embodiments, VIA computer device 224 determines 816 parking spaces 602 based on the spacing of vehicles 518 in parking area 512. VIA computer device 224 distinguishes 818 vehicles 518 from parking area surface 606. VIA computer device 224 may distinguish vehicles 518 through many methods includes, but not limited to, recognizing vehicles 518 based on the known size of vehicles 518, through the changes in overhead images 510 based on vehicles 518 moving between overhead images 510, based on the difference in color between vehicles 518 and parking area surface 606, and based on the different infrared signature that vehicles 518 provide in comparison to that of parking area surface 606. Once vehicles 518 are distinguished from parking area surface, VIA computer device 224 counts 820 vehicles 518 in the selected parking area 512. If there are more parking areas, then VIA computer device 224 returns to Step 814 for each of the additional parking areas 512.

In some embodiments, VIA computer device 224 individually identifies each vehicle 518 in parking area 512. For example, VIA computer device 224 may identify each vehicle 518 by shape and color. By comparing different overhead images 510, VIA computer device 224 is able to determine the length of time that each vehicle 518 visits merchant location 516. Additionally, VIA computer device 224 is able to determine a number of unique vehicle visits to merchant location 516.

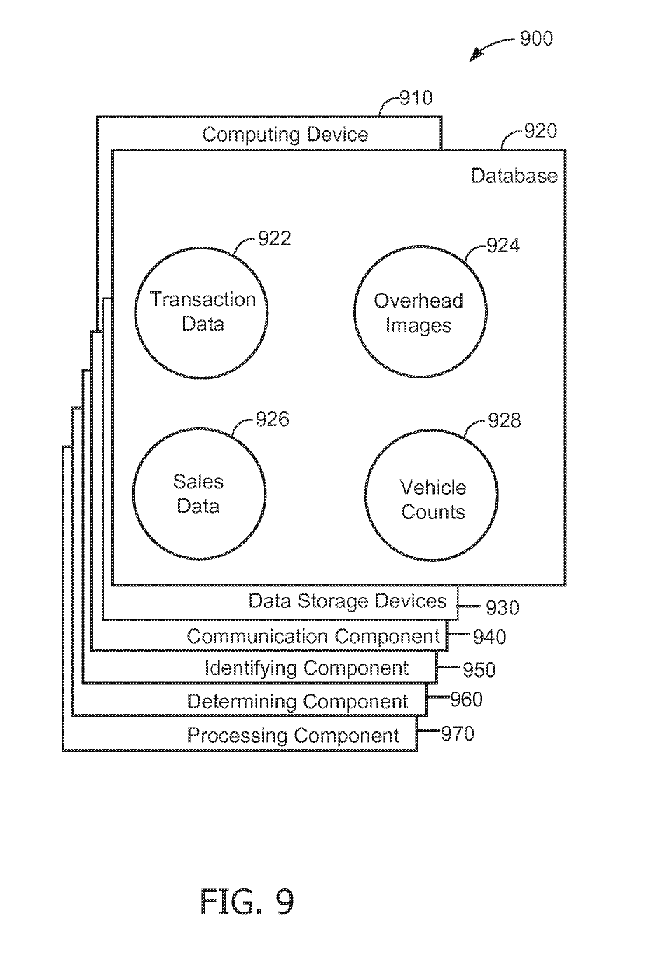

FIG. 9 is a diagram 900 of components of one or more example computing devices that may be used in the system 200 shown in FIG. 2. In some embodiments, computing device 910 is similar to server system 212; it may also be similar to VIA computer device 224 (both shown in FIG. 2). A database 920 may be coupled with several separate components within computing device 910, which perform specific tasks. In this embodiment, database 920 includes transaction data 922, overhead images 924, which may be overhead images 510 (shown in FIG. 5), sales data 926, and vehicle counts 928. In some embodiments, database 920 is similar to database 220 (shown in FIG. 2).

Computing device 910 includes database 920, as well as data storage devices 930. Computing device 910 also includes a communication component 940 for receiving 702 an overhead image and receiving 708 transaction data, both shown in FIG. 7. Computing device 910 also includes an identifying component 950 for identifying 704 at least one parking area, as shown in FIG. 7. A determining component 960 is also included for determining 706 a number of vehicles in each identified parking area and determining 710 sales data, both shown in FIG. 7. A processing component 970 assists with execution of computer-executable instructions associated with the system.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for determining merchant sales data using overhead imagery, the method implemented using a valuation computer device in communication with a memory, the method comprising:
receiving, by the valuation computer device, a first overhead image of an area surrounding a merchant, wherein the first overhead image associated with a first image date and time;
identifying at least one parking area associated with the merchant location based on the first overhead image;
determining, by the valuation computer device, a first number of vehicles in the at least one parking area based on the first overhead image and the at least one parking area;
receiving, by the valuation computer device, a plurality of transaction data associated with the merchant location for a first predefined period of time associated with the first image date and time; and
determining, by the valuation computer device, a first set of sales data for the merchant location based on the plurality of transaction data and the first number of vehicles.

2. A method in accordance with claim 1, further comprising:
receiving a second overhead image of the area surrounding the merchant, wherein the second overhead image associated with a second time date and time;
determining, by valuation computer device, a second number of vehicles in the at least one parking area based on the second overhead image and the at least one parking area;
receiving, by the valuation computer device, a plurality of transaction data associated with the merchant location for a second predefined period of time associated with the second image date and time; and
determining, by the valuation computer device, a second set of sales data for the merchant location based on the plurality of transaction data and the second number of vehicles.

3. A method in accordance with claim 2, further comprising:
comparing at least the first set of sales data and the second set of sales data; and
determining at least one trend based on the comparison.

4. A method in accordance with claim 2, further comprising determining length of visit data based on the first number of vehicles, the first date and time, the second number of vehicle, and the second date and time.

5. A method in accordance with claim 4, wherein determining length of visit data further comprises:
uniquely identifying each vehicle in the first overhead image;
uniquely identifying each vehicle in the second overhead image; and
comparing the uniquely identified vehicles from the first overhead image with the uniquely identified vehicles from the second overhead image.

6. A method in accordance with claim 1, wherein the first overhead image includes infrared data and wherein identifying at least one parking area further based on the infrared data.

7. A method in accordance with claim 6, wherein determining a first number of vehicles further comprises identifying at least one vehicle based on a difference of an amount of heat emanating from the at least one vehicle and an amount of heat emanating from the at least one parking area where the at least one vehicle is located.

8. A method in accordance with claim 1, further comprising identifying the merchant location based on the first overhead image.

9. A method in accordance with claim 1, further comprising identifying a plurality of merchant locations associated with the at least one parking area based on the first overhead image.

10. A method in accordance with claim 9, further comprising:
identifying which vehicles of the first number of vehicles in the at least one parking area associated with each of the plurality of merchant locations;
receiving a plurality of transaction data associated with each of the plurality of merchant locations for a first predefined period of time associated with the first image date and time; and
determining a set of sales data for each of the plurality of merchant locations based on the plurality of transaction data and the identified vehicles associated with the corresponding merchant location.

11. A valuation computing device for determining merchant sales data using overhead imagery, said valuation computing device comprising one or more processors communicatively coupled to one or more memory devices, said valuation computing device configured to:
receive a first overhead image of an area surrounding a merchant location, wherein the first overhead image associated with a first image date and time;
identify at least one parking area associated with the merchant location based on the first overhead image;
determine a first number of vehicles in the at least one parking area based on the first overhead image and the at least one parking area;
receive a plurality of transaction data associated with the merchant location for a first predefined period of time associated with the first image date and time; and
determine a first set of sales data for the merchant location based on the plurality of transaction data and the first number of vehicles.

12. The valuation computing device in accordance with claim 11, the valuation computing device is further configured to:
receive a second overhead image of the area surrounding the merchant location, wherein the second overhead image associated with a second time date and time;
determine a second number of vehicles in the at least one parking area based on the second overhead image and the at least one parking area;
receive a plurality of transaction data associated with the merchant location for a second predefined period of time associated with the second image date and time; and
determine a second set of sales data for the merchant location based on the plurality of transaction data and the second number of vehicles.

13. The valuation computing device in accordance with claim 12 the valuation computing device is further configured to:
compare at least the first set of sales data and the second set of sales data; and
determine at least one trend based on the comparison.

14. The valuation computing device in accordance with claim 12, the valuation computing device is further configured to determine length of visit data based on the first number of vehicles, the first date and time, the second number of vehicle, and the second date and time.

15. The valuation computing device in accordance with claim 14, the valuation computing device is further configured to:
uniquely identify each vehicle in the first overhead image;
uniquely identify each vehicle in the second overhead image; and
compare the uniquely identified vehicles from the first overhead image with the uniquely identified vehicles from the second overhead image.

16. The valuation computing device in accordance with claim 11, wherein the first overhead image includes infrared data and wherein the valuation computing device is further configured to identify the at least one parking area based on the infrared data.

17. The valuation computing device in accordance with claim 16, wherein the valuation computing device is further configured to identify at least one vehicle based on a difference of an amount of heat emanating from the at least one vehicle and an amount of heat emanating from the at least one parking area where the at least one vehicle is located.

18. The valuation computing device in accordance with claim 11, wherein the valuation computing device is further configured to identify a plurality of merchant locations associated with the at least one parking area based on the first overhead image.

19. The valuation computing device in accordance with claim 19, wherein the valuation computing device is further configured to:
identify which vehicles of the first number of vehicles in the at least one parking area associated with each of the plurality of merchant locations;
receive a plurality of transaction data associated with each of the plurality of merchant locations for a first predefined period of time associated with the first image date and time; and
determine a set of sales data for each of the plurality of merchant locations based on the plurality of transaction data and the identified vehicles associated with the corresponding merchant location.

20. A computer-readable storage medium having computer-executable instructions embodied thereon, wherein when executed by a valuation computing device having at least one processor coupled to at least one memory device, the computer-executable instructions cause the at least one processor to:
receive a first overhead image of an area surrounding a merchant location, wherein the first overhead image associated with a first image date and time;
identify at least one parking area associated with the merchant location based on the first overhead image;
determine a first number of vehicles in the at least one parking area based on the first overhead image and the at least one parking area;
receive a plurality of transaction data associated with the merchant location for a first predefined period of time associated with the first image date and time; and
determine a first set of sales data for the merchant location based on the plurality of transaction data and the first number of vehicles.
